(19) United States
(12) Patent Application Publication
(10) Pub. No.: US 2018/0126399 A1
(43) Pub. Date: May 10, 2018

(54) PUMP TYPE DISPENSER

(71) Applicants: Hiroshi MIZUSHIMA, Tokyo (JP); Tsuyoshi SASAKI, Tokyo (JP)

(72) Inventors: Hiroshi MIZUSHIMA, Tokyo (JP); Tsuyoshi SASAKI, Tokyo (JP)

(73) Assignee: YOSHINO KOGYOSHO CO., LTD., Tokyo (JP)

(21) Appl. No.: 15/576,630

(22) PCT Filed: May 20, 2016
(86) PCT No.: PCT/JP2016/065092

§ 371 Date: Nov. 22, 2017

(30) Foreign Application Priority Data
May 29, 2015 (JP) 2015-109501

(51) Int. Cl. B05B 11/00

(52) U.S. Cl. CPC B05B 11/0089; B05B 11/3047; B05B 11/3001

(57) ABSTRACT

Disclosed in the present invention is a pump type dispenser which includes a pump held by a mouth portion of a container and configured to suction and pressure-feed a content liquid in the container, and a nozzle head having an internal passage through which the pressure-fed content liquid passes and driving the pump by being repeatedly pushed down and restored. The internal passage includes a vertical passage, a lateral passage, and a protrusion protruding toward an inner side in a joining portion between the vertical passage and the lateral passage, and a dispensing member disposed in the lateral passage includes a recessed portion which engages with the protrusion to prevent separation from the lateral passage.

### TECHNICAL FIELD

The present invention relates to a pump type dispenser which dispenses a content liquid with which a container is filled toward the outside, and particularly relates to a pump type dispenser including a dispensing member capable of dispensing a content liquid in a predetermined form. Priority is claimed on Japanese Patent Application No. 2015-109501, filed May 29, 2015, the content of which is incorporated herein by reference.

### BACKGROUND ART

In containers filled with content liquids such as shampoos, body soaps, hand soaps, or facial cleansers, a pump type dispenser held by a mouth portion of the container is frequently used. In such a pump type dispenser, the pump is driven by repeatedly pushing down a nozzle head which then be restored to dispense the content liquid.

In such a pump type dispenser, although it is common to directly dispense a content liquid from an opening at a distal end of the nozzle head, there are pump type dispensers in which a dispensing member (mouthpiece) is attached to the opening at the distal end of the nozzle head to dispense the content liquid in a predetermined form (for example, dispensing the content liquid divided into a plurality of portions, dispensing the content liquid from a longer distance than usual, or the like) (see Patent Document 1, for example).

### CITATION LIST

### Patent Document

### [Patent Document 1]

Japanese Patent Publication No. 3609486

### SUMMARY OF INVENTION

### Technical Problem

However, in such a pump type dispenser, it is necessary for a pump type dispenser to have a function of holding a dispensing member and preventing it from being separated so that the dispensing member is not accidentally detached from a nozzle head. In a pump type dispenser disclosed in Patent Document 1, a protruding portion is provided on an outer peripheral surface of a dispensing member, a recessed portion is provided inside a passage of a nozzle head, and the protruding portion is fitted into the recessed portion so that the dispensing member is held and prevented from being separated by the nozzle head.

That is, the recessed portion provided in the passage of the nozzle head is undercut. Therefore, it is necessary to consider releasability when molding the nozzle head.

The present invention has been made to solve the above problems, and it is an object of the present invention to provide a pump type dispenser capable of holding a dispensing member and preventing it from being separated without using a recessed portion provided in a conventional nozzle head.

### Solution to Problem

A first aspect of the present invention is a pump type dispenser which includes a pump held by a mouth portion of a container and configured to suction and pressure-feed a content liquid in the container, and a nozzle head having an internal passage through which the pressure-fed content liquid passes and driving the pump by being repeatedly pushed down and restored. In the present pump type dispenser, the internal passage includes a vertical passage communicating with the pump and a lateral passage connected to the vertical passage and that opens toward the outside, and includes a protrusion protruding toward an inner side in a joining portion between the vertical passage and the lateral passage, a dispensing member extending from the opening of the internal passage toward the joining portion and configured to dispense the content liquid introduced from an inlet on the joining portion side from an outlet on the opening side is disposed in the lateral passage, and the dispensing member includes a recessed portion which engages with the protrusion to prevent separation from the lateral passage.

In a second aspect of the present invention, in the pump type dispenser of the first aspect, the dispensing member is made of a resin having flexibility and is bent with respect to an initial state after molding when disposed in the lateral passage.

In a third aspect of the present invention, in the pump type dispenser of the first aspect or second aspect, the vertical passage includes a vertical rib protruding toward an inner side and extending along the vertical passage, and the dispensing member includes a notch portion which engages with the vertical rib.

In a fourth aspect of the present invention, in the pump type dispenser of the third aspect, a foam member which foams the content liquid is provided on a downstream side of the pump and the vertical rib comes into contact with an upper end of the foam member.

### Advantageous Effects of the Invention

According to a pump type dispenser of the present invention, a protrusion is provided in a joining portion between a vertical passage and a lateral passage in a nozzle head, and a dispensing member disposed in the lateral passage extends from an opening of the nozzle head toward the joining portion and includes a recessed portion which engages with the protrusion. Thereby, the protrusion (protruding portion) engages with the recessed portion so that the dispensing member can be held and prevented from being separated. In addition, when forming the nozzle head, a mold portion for forming the vertical passage and a mold portion for forming the lateral passage abut against each other in the joining portion between the vertical passage and the lateral passage. However, since the protrusion can be provided on the abutment surface, the protrusion does not become undercut when the nozzle head is released from the mold portion and thus good mold releasability can be obtained.

In addition, according to the pump type dispenser of the present invention, the dispensing member is made of a resin having flexibility and is bent (that is, in a bent state) with respect to an initial state after molding when disposed in the lateral passage. Thereby, the dispensing member is disposed in the lateral passage in a state in which it receives an urging force from the lateral passage. That is, even when a force is generated in a direction that causes the dispensing member to be separated from the nozzle head, since a resistance force is generated between the dispensing member and the lateral passage, it is possible to more reliably prevent the dispensing member from being separated and the engagement between the protruding portion and the recessed portion can be reliably maintained.

In addition, according to the pump type dispenser of the present invention, the vertical passage includes a vertical rib protruding toward an inner side and extending along the vertical passage and the dispensing member includes a notch portion which engages with the vertical rib. Thereby, it is possible to prevent the dispensing member from deviating in a direction crossing the vertical rib with respect to the nozzle head.

In addition, according to the pump type dispenser of the present invention, a foam member is provided on a downstream side of the pump. Thereby, since the content liquid can be foamed, it is easy to maintain a form of the content liquid dispensed from the dispensing member. Also, the vertical rib is in contact with an upper end of the foam member. Thereby, it is possible for the vertical rib to have a function of preventing the foam member from being separated (a function of positioning).

### BRIEF DESCRIPTION OF DRAWINGS

FIG. 1 is a cross-sectional view showing one embodiment of a pump type dispenser according to the present invention.

FIG. 2 is a plan view of the pump type dispenser shown in FIG. 1 and is a front view of a dispensing head constituting a dispensing member.

FIG. 3A shows a plan view, a cross-sectional view, a front view, and a rear view showing an initial state of an insertion member constituting the dispensing member.

FIG. 3B is a cross-sectional view showing a state in which the insertion member is bent when disposed in a lateral passage.

(a) of FIG. 4 is a partially enlarged cross-sectional view of a portion X in FIG. 1, and (b) of FIG. 4 is a cross-sectional view taken along line Y-Y shown in (a) of FIG. 4.

FIG. 5 is a partially enlarged cross-sectional view for describing a formation position of a protrusion formed in a joining portion.

### DESCRIPTION OF EMBODIMENTS

Hereinafter, one embodiment of a pump type dispenser according to the present invention will be described in detail with reference to the drawings. In the specification, claims, and abstract of the present application, “upper” refers to a side on which a nozzle head is positioned with respect to a base cap to be described below, and “lower” refers to a side opposite thereto. In addition, “front” refers to a side on which an opening of the nozzle head is positioned with respect to a central axis of the nozzle head, and “rear” refers to the opposite side.

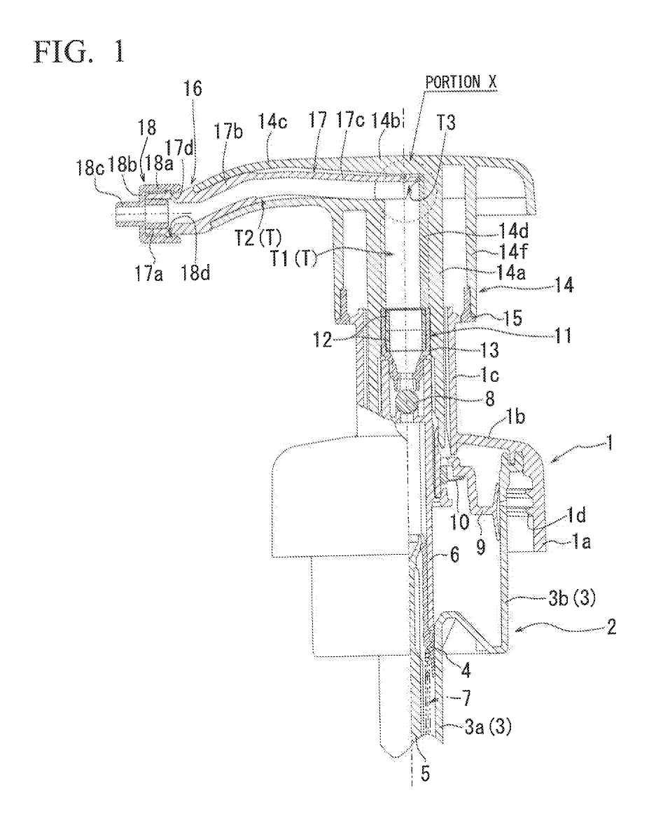

In FIG. 1, reference sign 1 shows a base cap mounted on a mouth portion of a container (not shown). The base cap 1 includes a cylindrical circumferential wall 1a which surrounds the mouth portion of the container, a donut-shaped top surface wall 1b which extends toward a radial inner side from an upper end of the circumferential wall 1a, and a cylindrical wall 1c which stands up from an inner circumferential edge of the top surface wall 1b. Also, on an inner circumferential surface of the circumferential wall 1a, a female screw portion 1d which engages with a male screw portion provided at the mouth portion of the container is provided. In order to hold the base cap 1 in the container, other conventionally known engaging member such as undercut may be used.

In FIG. 1, reference sign 2 shows a pump suspended and held by the mouth portion of the container by the base cap 1 and configured to pump up a content liquid with which the container is filled. The pump 2 includes a cylinder 3, a content liquid piston 4, a poppet 5, a stem 6, a spring 7, a ball valve 8, an air piston 9, and a check valve 10. The cylinder 3 includes a small-diameter cylindrical body 3a and a large-diameter cylindrical body 3b which are arranged in series. The content liquid piston 4, the poppet 5, the stem 6, the spring 7, the ball valve 8, the air piston 9, and the check valve 10 are incorporated in the cylinder 3. The pump 2 suctions, pressurizes, and pressure-feeds the content liquid and air individually when the stem 6 is pushed down and restored.

Reference sign 11 shows a foam member in which the content liquid and air pressure-fed from the pump 2 join to foam the content liquid. The foam member 11 of the present embodiment is provided at an upper portion of the stem 6. The foam member 11 is constituted by a mesh ring 12 in which a mesh is attached to one end portion of a ring-shaped main body portion and a jet ring 13 which holds the mesh ring 12 (holds two mesh rings 12 in the present embodiment).

Reference sign 14 shows a nozzle head. The nozzle head 14 includes an inner cylinder 14a surrounding the foam member 11 and connecting it to the stem 6, a top wall 14b serving as a pressing portion for pushing down the nozzle head when the stem 6 connected to the inner cylinder 14a is pushed down, and a nozzle 14c connected to the top wall 14b and extending in a lateral direction. Also, inside the nozzle head 14, an internal passage T including a vertical passage T1 formed inside the inner cylinder 14a and a lateral passage T2 formed inside the nozzle 14c are provided. In addition, one end of the lateral passage T2 is connected to the vertical passage T1 and the other end thereof opens toward the outside. In addition, in the rear of an inner surface of the inner cylinder 14a, a vertical rib 14d extending along the vertical passage T1 is provided. The vertical rib 14d is in contact with an upper end of the jet ring 13 to cover a portion of the mesh ring 12 and prevents the mesh ring 12 and the jet ring 13 from being separated.

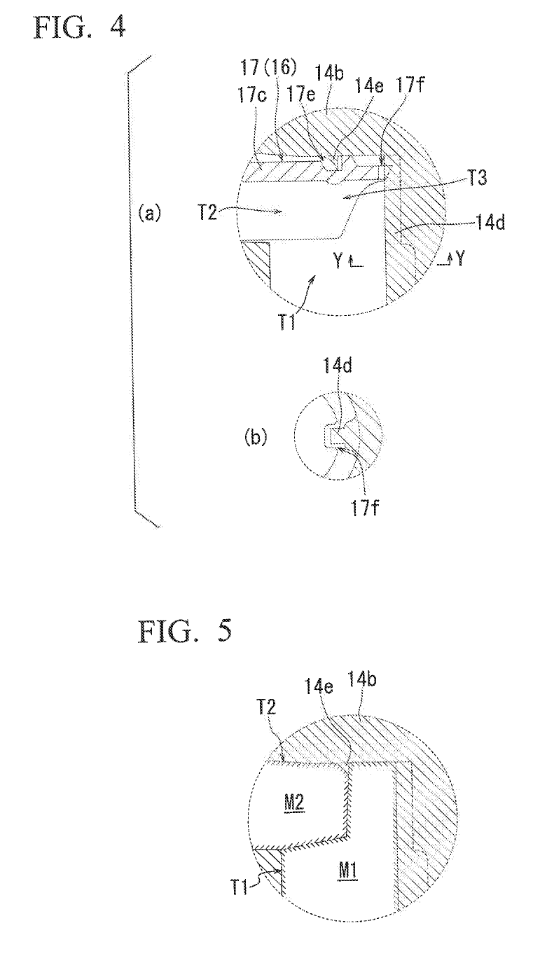

As shown in FIGS. 4 and 5, a protrusion 14e protruding from the top wall 14b toward the inside (the internal passage T) is provided in a joining portion T3 in which the vertical passage T1 and lateral passage T2 are connected. As shown in FIG. 5, the protrusion 14e of the present embodiment is formed on an abutment surface between a mold portion M1 for forming the vertical passage T1 and a mold portion M2 for forming the lateral passage T2 at the time of molding the nozzle head 14. Specifically, since an upper end portion of a rear end of the mold portion M2 is inclined (curved in the present embodiment), a space is formed between an upper end surface of an abutment surface of the mold portion M1 and an upper end surface of an abutment surface of the mold portion M2 when the mold portion M1 and the mold portion M2 abut against each other. The protrusion 14e is formed due to the space generated at the time of molding the nozzle head 14. That is, since this space is merely surrounded by the upper end surface of the abutment surface of the mold portion M1 and the upper end surface of the abutment surface of the mold portion M2, the protrusion 14e after molding is not an obstacle when removing the nozzle head 14 after the molding from the mold portion M1 and the mold portion M2. Thus, since the protrusion 14e does not become undercut, good mold releasability can be obtained.

Also, as shown in FIG. 1, the nozzle head 14 includes an outer cylinder 14f which surrounds the inner cylinder 14a. Further, an annular member 15 attached to a lower end of the outer cylinder 14f to reduce a gap with the cylindrical wall 1c of the base cap 1 is provided in the present embodiment.

A dispensing member 16 is disposed in the lateral passage T2. The dispensing member 16 of the present embodiment includes an insertion member 17 which extends from an opening of the nozzle 14c toward the joining portion T3 and a dispensing head 18 attached to a front of the insertion member 17.

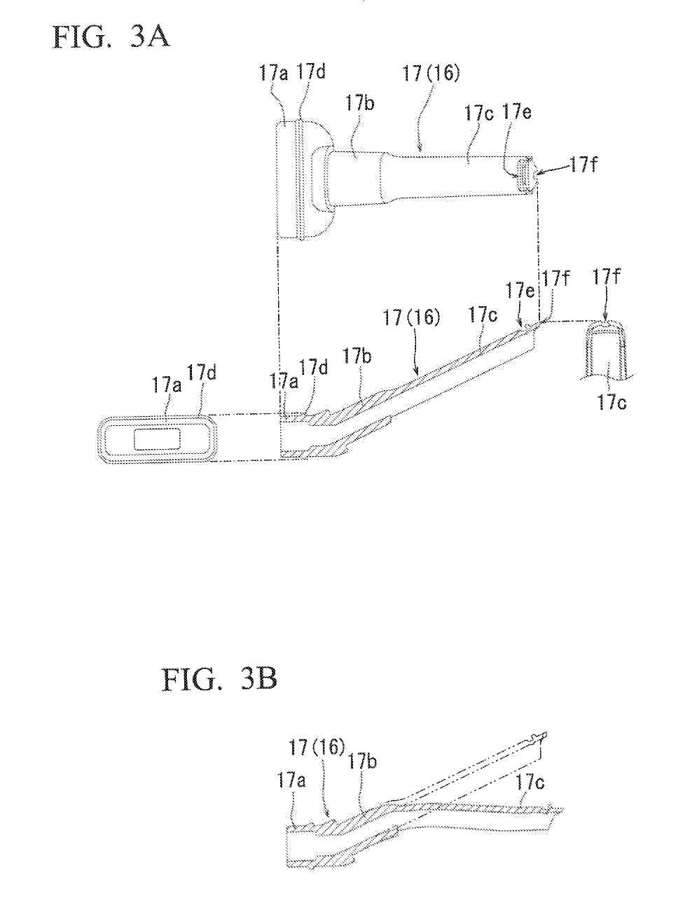

As shown in FIG. 3A, the insertion member 17 includes a rectangular base portion 17a, an annular wall 17b extending obliquely upward from a rear end of the base portion 17a and having a rectangular shape smaller than the base portion 17a, and a tubular wall 17c extending in the same direction as an extension direction of the annular wall 17b from a rear end of the annular wall 17b and having a U-shaped cross section with its lower side open. In addition, a protruding portion 17d which protrudes toward an outer side is provided on an outer peripheral surface of the base portion 17a, and a groove-shaped recessed portion 17e is provided on an upper surface of a rear end side of the tubular wall 17c. In addition, the recessed portion 17e may be a through hole penetrating the tubular wall 17c. Further, a notch portion 17f is provided in a center portion of a rear end of the tubular wall 17c. FIG. 3A shows the insertion member 17 in an initial state after molding.

The insertion member 17 is made of a resin having flexibility and is bent downward as shown by a solid line in FIG. 3B when disposed in the lateral passage T2 as compared with an initial state shown by a virtual line in FIG. 3B.

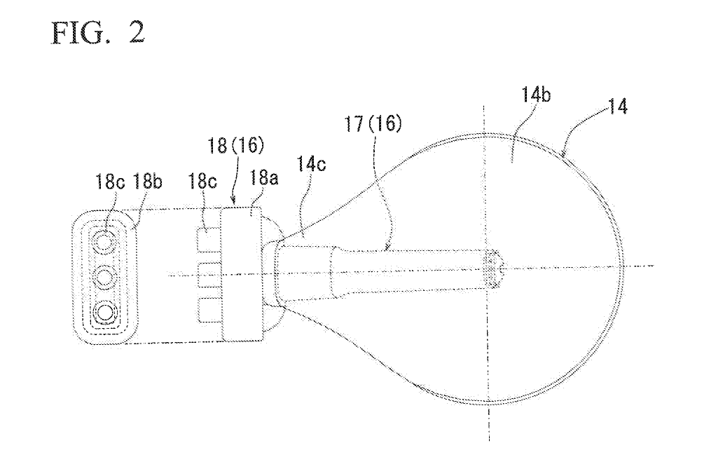

As shown in FIGS. 1 and 2, the dispensing head 18 includes a rectangular outer wall 18a surrounding the base portion 17a of the insertion member 17, a top wall 18b provided at a front end of the outer wall 18a, and a cylindrical dispensing tube 18c extending toward a front side from the top wall 18b (in the present embodiment, three dispensing tubes 18c in total are arranged in a line). In addition, a claw portion 18d engaging with the protruding portion 17d is provided on an inner peripheral surface of the outer wall 18a.

When the dispensing member 16 including the insertion member 17 and the dispensing head 18 as described above is disposed in the lateral passage T2, the recessed portion 17e engages with the protrusion 14e as shown in (a) of FIG. 4. Therefore, the dispensing member 16 is held and prevented from being separated from the nozzle head 14. At this time, the insertion member 17 is in the bent state (bent state) as compared with the initial state. Therefore, a portion of the insertion member 17 comes into contact with the nozzle head 14 while pressing against the nozzle head 14 due to a restoring force that restores the initial state from the bent state. In the present embodiment, since the tubular wall 17c has a U-shaped cross section (since there are walls not only on the top portion but also on both sides), an elastic force of the tubular wall 17c becomes stronger than when there is no wall on either side portion. Thereby, the insertion member 17 can be brought into contact with the nozzle head 14 while pressing against the nozzle head 14 with even greater restoring force. Therefore, even when a force is generated in a direction that causes the insertion member 17 to be separated from the nozzle head 14, since a resistance force is generated between the nozzle head 14 and the insertion member 17, it is possible to more reliably prevent the insertion member 17 from being separated. In addition, since the restoring force that restores the initial state from the bent state of the insertion member 17 acts in an upward direction, the engagement of the recessed portion 17e with respect to the protrusion 14e is made even stronger and more reliable and it is possible to more reliably prevent the insertion member 17 from being separated. The annular wall 17b of the insertion member 17 is in close contact with an inner surface of the nozzle 14c (a surface forming the lateral passage T2). Therefore, the content liquid does not leak out from a region in which the annular wall 17b of the insertion member 17 and the inner surface of the nozzle 14c are in contact with each other.

Although the preferred embodiments of the present invention have been described with reference to the drawings, the present invention is not limited to the above-described embodiments. The shapes and combinations of the constituent members or the like shown in the above-described embodiments are merely examples, and various modifications can be made based on design requirements or the like without departing from the scope of the present invention.

For example, in the above embodiment, the foam member is provided for the pump type dispenser, but the foam member may not be provided and the content liquid may be directly dispensed. Also, the number, arrangement, hole diameter, or the like of the dispensing tube provided in the dispensing head may be appropriately changed in accordance with a desired dispensing mode of the content liquid. In addition, the pump is not limited to the pump of the aspect described above, and conventionally known pumps of other aspects may be used.

### INDUSTRIAL APPLICABILITY

According to the pump type dispenser of the present invention, a dispensing member can be held and prevented from being separated. Further, it is possible to obtain good mold releasability when forming a nozzle head.

### REFERENCE SIGNS LIST

1 Base cap
1a Circumferential wall
1b Top surface wall
1c Cylindrical wall
1d Female screw portion
2 Pump
3 Cylinder
3a Small-diameter cylindrical body
3b Large-diameter cylindrical body
4 Content liquid piston
5 Poppet
6 Stem
7 Spring
8 Ball valve
9 Air piston
10 Check valve
11 Foam member
12 Mesh ring
13 Jet ring
14 Nozzle head
14a Inner cylinder
14b Top wall
14c Nozzle
14d Vertical rib
14e Protrusion
14f Outer cylinder
15 Annular member
16 Dispensing member
17 Insertion member
17a Base portion
17b Annular wall
17c Tubular wall
17d Protruding portion
17e Recessed portion
17f Notch portion
18 Dispensing head
18a Outer wall
18b Top wall
18c Dispensing tube
18d Claw portion
M1 Mold portion for forming vertical passage
M2 Mold portion for forming lateral passage
T Internal passage
T1 Vertical passage
T2 Lateral passage
T3 Joining portion

1. A pump type dispenser comprising:
a pump held by a mouth portion of a container and configured to suction and pressure-feed a content liquid in the container; and
a nozzle head having an internal passage through which the pressure-fed content liquid passes and driving the pump by being repeatedly pushed down and restored, wherein
the internal passage includes a vertical passage communicating with the pump and a lateral passage connected to the vertical passage and that opens toward the outside, and includes a protrusion protruding toward an inner side in a joining portion between the vertical passage and the lateral passage,
a dispensing member extending from the opening of the internal passage toward the joining portion and configured to dispense the content liquid introduced from an inlet on the joining portion side from an outlet on the opening side is disposed in the lateral passage, and
the dispensing member includes a recessed portion which engages with the protrusion to prevent separation from the lateral passage.

2. The pump type dispenser according to claim 1, wherein the dispensing member is made of a resin having flexibility and is bent with respect to an initial state after molding when disposed in the lateral passage.

3. The pump type dispenser according to claim 1, wherein the vertical passage includes a vertical rib protruding toward an inner side and extending along the vertical passage and the dispensing member includes a notch portion which engages with the vertical rib.

4. The pump type dispenser according to claim 2, wherein the vertical passage includes a vertical rib protruding toward an inner side and extending along the vertical passage and the dispensing member includes a notch portion which engages with the vertical rib.

5. The pump type dispenser according to claim 3, wherein a foam member which foams the content liquid is provided on a downstream side of the pump and the vertical rib comes into contact with an upper end of the foam member.

6. The pump type dispenser according to claim 4, wherein a foam member which foams the content liquid is provided on a downstream side of the pump and the vertical rib comes into contact with an upper end of the foam member.
